(19) United States
(12) Patent Application Publication
(10) Pub. No.: US 2008/0006501 A1
(43) Pub. Date: Jan. 10, 2008

(54) MULTI-DISK CLUTCH OR MULTI-DISK BRAKE WITH AXIAL OIL FLOW

(75) Inventors: Josef Haupt, Tettnang (DE); Thilo Schmidt, Meckenbeuren (DE); Peter Schiele, Kressbronn (DE); Tobias Miller, Waldburg (DE); Christian Schwemer, Sigmarszell (DE)

Correspondence Address: DAVIS BUJOLD & Daniels, P.L.L.C., 112 PLEASANT STREET, CONCORD, NH, 03301, US

(73) Assignee: ZF FRIEDRICHSHAFEN AG, Friedrichshafen (DE)

(21) Appl. No.: 11/775,304

(22) Filed: Jul. 10, 2007

(30) Foreign Application Priority Data
Jul. 10, 2006 (DE) 102006031785.8

(51) Int. Cl. F16D 13/72

(52) U.S. Cl. 192/70.12; 192/85 AA; 192/113.34

(57) ABSTRACT

The invention relates to a multi-disk clutch or multi-disk brake (1, 2), comprising an inner disk carrier (4) carrying internal disks (3) and an outer disk carrier (6) carrying external disks (5), friction linings (7, 7′) on the internal and external disks (3, 5), a first end disk (9), on which a closing force for the multi-disk clutch or multi-disk brake can be applied by a piston (10) of a piston-cylinder arrangement which can be actuated by a pressure medium, and a second end disk (8), which forms an axial abutment for the clutch pack (14) formed by the disks (3, 5, 8, 9), wherein the multi-disk clutch or multi-disk brake (1, 2) and/or the components encompassing the clutch or the brake are configured such that the internal and external disks (3, 5) can be wetted with a cooling oil (13). So as to improve heat dissipation during operation, it is provided that the multi-disk clutch or multi-disk brake (1, 2) is configured such that the cooling oil (13) can be directed axially through the clutch pack (14).

This application claims priority from German Application Serial No. 10 2006 031 785.8 filed Jul. 10, 2006.

### FIELD OF THE INVENTION

The invention relates to a multi-disk clutch or multi-disk brake comprising an inner disk carrier carrying internal disks and an outer disk carrying external disks, friction linings on the internal and external disks, a first end disk, on which an engaging force for the multi-disk clutch or multi-disk brake can be applied by a piston of a piston-cylinder arrangement which can be actuated by pressure medium, and a second end disk, which forms an axial abutment for the clutch pack formed by the disks, and wherein the multi-disk clutch or multi-disk brake and/or the components encompassing the clutch or the brake are configured such that the internal and the external disks can be wetted with a cooling oil.

### BACKGROUND OF THE INVENTION

Multi-disk clutches or multi-disk brakes of this type are known in various embodiments. For example, they are used as shifting elements in automatic transmissions for motor vehicles. When configured as a wet-running multi-disk clutch, the clutch is provided as a starting clutch in a motor vehicle transmission or also outside of such a transmission. Wet-running starting clutches are typically cooled radially from the inside by means of cooling oil, since as a result of the rotation of the input side or output side of the clutch, this cooling oil is spun radially outward and therefore a pumping action is achieved for the cooling oil heated in the clutch.

In the case of a wet-running multi-disk brake which is used, for example, as a shifting member in an automatic multi-ratio transmission, this radial conveyance of the cooling oil is not possible or is possible only with great difficulty because, during the engagement of the brake, a rotating brake component is brought to a halt against a stationary brake component while absorbing energy. Brakes of this type, therefore, are typically operated either entirely immersed in the cooling oil, or they are supplied with cooling oil in a predefined manner from the outside via a pressure difference.

A conventional wet-running multi-disk clutch is known, for example, from German Patent DE 41 36 040 C1 wherein the supply of cooling oil to the clutch disks takes place from radially inward to radially outward. For this purpose, radial openings are provided in an inner disk carrier in the region under the friction linings of the clutch disks and the cooling oil can be selectively directed through these openings to the disks.

Furthermore, a wet-running multiple disk clutch or multiple disk brake is known from German Patent DE 102 30 183 A1 wherein the cooling fluid flows through the clutch pack, formed by the clutch disks, from radially inward to radially outward or from radially outward to radially inward. The cooling fluid flow is maintained by a defined pressure difference between the cooling fluid supply and the discharge of the cooling fluid in the clutch pack.

### SUMMARY OF THE INVENTION

The objective of the invention is based upon furthering develop a wet-running multi-disk clutch or multi-disk brake such that it can be cooled better than before with a cooling oil or another cooling fluid.

The solution to this objective is apparent from the characteristics of the main claim, and advantageous embodiments or further developments of the invention are disclosed in the dependent claims.

The invention is based on the realization that the evacuation of heat, from a multi-disk clutch or multi-disk brake, can be improved if the cooling oil is pumped in a predefined manner through the same such that, on the one hand, the cooling oil volume coming in contact with the disk surfaces to be cooled per unit of time is increased and, on the other hand, the cooling oil can reach the friction linings of the disk to be cooled better than before.

Accordingly, the invention relates to a multi-disk clutch or multi-disk brake, comprising an inner disk carrier carrying internal disks and an outer disk carrier carrying external disks, friction linings on the internal and the external disks, a first end disk, on which an engaging force for the multi-disk clutch or multi-disk brake can be applied by a piston of a pressurant-actuated piston-cylinder arrangement, and a second end disk which forms an axial abutment for the clutch pack formed by the disks, and wherein the multi-disk clutch or multi-disk brake and/or the components encompassing the clutch or the brake are configured such that the internal and the external disks can be wetted with a cooling oil. So as to improve heat dissipation during operation, it is furthermore provided that the multi-disk clutch or multi-disk brake is configured such that cooling oil can be directed axially through the clutch pack.

In a particularly preferred further development of the invention, it is provided that the multi-disk clutch or multi-disk brake is configured such that cooling oil can be directed alternately axially and radially through the clutch pack. This configuration allows the cooling oil to remain in the clutch pack for a comparatively long time and with intense heat exchange.

The supply and discharge of the cooling oil preferably occurs axially through the two end disks, whereby at least one axial orifice for the oil supply or oil discharge is provided, respectively.

In a further embodiment of the invention, each of the internal disks and the external disks is provided with at least one axial orifice to enable particularly easy axial passage of the cooling oil through the clutch pack. In this context, a design is preferred wherein at least one axial orifice is provided in each internal disk or external disk, disposed a radial distance in front of a radial end of the respective disk.

According to a further refinement, it is provided that the aforementioned axial orifices, in the internal disks or external disks, are disposed radially remote from or radially close to the associated inner disk carrier or outer disk carrier, respectively, in order to increase further the path of the cooling oil through the clutch pack and as a result the usable heat exchange surface.

According to a another characteristic of an inventive multi-disk clutch or multi-disk brake, it is provided that the internal disks and the external disks carry a friction lining only on one of the two axial sides (single-side disks) and that this friction lining points, within the clutch pack, in the same axial direction.

It is advantageous if the cooling oil can be directed through at least partially radial grooves in the friction lining of each internal disk and external disk. As a function of the respective requirements, these grooves in the friction lining of the internal disk or external disk may have different radial shapes. It is preferable, however, if the grooves in the friction linings are configured radially straight or radially arched. The friction lining-free side of the axially next disk, located opposite from the respective friction lining, closes the groove to form a cooling oil channel.

The combination of the axial orifices in the internal disks and the external disks, which are disposed close to the disk carrier or removed from the disk carrier, with the radial grooves in the friction linings enables alternate axial and radial flow of the cooling oil through the clutch pack, thus allowing more intense heat transmission than is the case with wet multi-disk clutches or multi-disk brakes according to the state of the art.

According to another further development of the invention, a radial sealing segment is provided, in the region of the radial end of each internal disk or external disk carrying a friction lining, which prevents radial exiting of the cooling oil from the clutch pack to prevent loss of the cooling oil from leakage from the path through the clutch pack and to ensure that downstream regions of the clutch pack are sufficiently supplied with cooling oil. In another further development of the invention, it is provided that this sealing segment is configured on the friction lining-free side of the disks.

The sealing segment is preferably made from the material of the friction lining or a separate friction-resistant sealant that is applied to the internal disk or the external disk.

In order to facilitate the entering of cooling oil into the clutch pack and also to minimize leakage losses in this region, another further development of the invention provides for a synchronizing teeth element, on the disk carrier, that enables the oil supply having no teeth in the catch profile in the region of the transfer point for cooling oil

A further improvement in the heat dissipation of the inventive multi-disk clutch or multi-disk brake can be achieved if at least some of the internal disks and external disks, radially encompassed by the two end disks, have at least one radially inner orifice and at least one radially outer orifice. As a result of this design, the cooling oil within the clutch pack not only flows alternately axially and radially through the same but, in addition, a circulatory flow about the internal disks or the external disks, provided with radially inner and radially outer orifices, is possible. In order to ensure the preferred alternate axial and radial flow through the clutch pack, it may furthermore be provided that the orifices disposed radially removed from one another in an interior disk or an exterior disk have different diameters and/or different flow resistance values.

In order to be able to feed the cooling oil into the clutch pack of the multi-disk clutch or multi-disk brake in a predefined manner, the oil is supplied to the clutch pack under pressure.

Finally, it may be provided that the cooling oil is pumped into an annular oil collecting chamber, which is configured adjacent to the end disk on the inflow side in the region of the multi-disk clutch or multi-disk brake, before passing through the clutch pack. In this way, particularly the distribution of the cooling oil is facilitated.

### BRIEF DESCRIPTION OF THE DRAWINGS

To illustrate the invention, the description and figures with exemplary embodiments are attached, wherein:

FIG. 1 is a schematic longitudinal section of a multi-disk brake with alternate axial and radial cooling oil feeding, and

FIG. 2 is a multi-disk brake according to FIG. 1 in which, however, a circulatory flow of cooling oil about the exterior disk is additionally implemented.

### DETAILED DESCRIPTION OF THE INVENTION

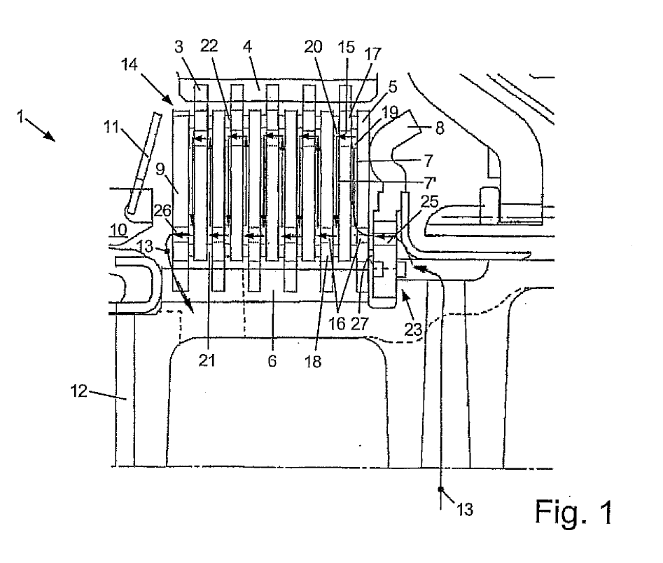

FIG. 1 accordingly shows a multi-disk brake 1, according to a first embodiment of the invention. This multi-disk brake 1 is configured, by way of example, as a shifting member of an automatic transmission and comprises, first of all, an inner disk carrier 4 carrying an internal disk with the carrier being connected to a rotatable component of the automatic transmission, the component not being illustrated here. Furthermore, the multi-disk brake 1 has an outer disk carrier 6 carrying an external disk 5, the carrier being non-rotatably connected to the housing 12 of the automatic transmission. The internal disks 3 and the external disks 5 are alternately disposed axially adjacent to each other and, together with two end disks 8 and 9, form a clutch pack 14. A piston 10 of a pressurant-actuated piston-cylinder arrangement can apply an axially actuating force, that engages the multi-disk brake 1, on one end disk 9 while the opposite end disk 8 is firmly connected to the housing 12 and forms an axial abutment for the entire clutch pack 14. A disk spring 11, disposed in the region of the end disk 9 on the piston side, ensures that the piston 10 is pushed back when it is not actuated.

Furthermore, the internal disks 3 and the external disks 5 each are provided with friction linings, wherein the friction linings 7, 7′ are respectively disposed to point in the same axial direction. The end disks 8 and 9 are constructed without friction linings.

This multi-disk brake 1 is cooled by a cooling oil current by means of cooling oil 13, which is very effectively directed between the individual internal disks 3 and the external disks 5 as well as the friction linings 7, 7′ thereof. For this purpose, the cooling oil 13 is first supplied under pressure to the end disk 8 forming the axial abutment, whereby the cooling oil 13 flows into the clutch pack 14 through the axial inflow orifice 25 of the end disk.

The cooling oil 13 flows from the inflow orifice 25 in the end disk 8 through an axial orifice 16 in the exterior disk 5, close to the end disk, into a radial groove 19 in the friction lining 7 of the same. The cooling oil 13 first flows within this radial groove 19 radially inward in the direction of the inner disk carrier 4. In the region of the radial end 17 of the internal disk 3, the end being close to the inner disk carrier, an axial orifice 15 is provided, through which the cooling oil 13 flows. From there, the cooling oil 13 reaches a radial groove 20 in the friction lining 7′ of the internal disk 3, so that the oil can continue to flow radially outward in the direction of the outer disk carrier 6.

At the end 18 close to the outer disk carrier, the next external disk 5 likewise comprises an axial orifice 16, through which the cooling oil 13 can then enter the radial groove 19 in the friction lining 7 of this external disk 5.

The current of the cooling oil 13 is generated by the cooling oil pressure on the inlet side as well as by a pump effect of the grooved and moving internal disks 3. Since the cooling oil 13, as mentioned above, flows with pressure into the clutch pack 14, this cooling oil current is also maintained for cooling the multi-disk brake 1 when the internal disks 3 are fully braked.

After the aforementioned alternate axial and radial flow through the clutch pack 14, the cooling oil 13 reaches the end disk 9 on the piston side and the cooling oil 13 is then discharged from the clutch pack via at least one axial discharge orifice 26 in the end disk.

The axial orifices 15 or 16, in the internal disks 3 and the external disks 5 can be disposed alternately in any arbitrary manner, however, it is preferred if these orifices 15 or 16 are provided radially close to the inner disk carrier 4 or outer disk carrier 5 associated with the respective disk.

FIG. 1 furthermore shows that the internal disks 3 and the external disks 5 at the respective radial end thereof that is removed from the carrier, have an annular sealing segment 21 or 22, which is preferably made of the material of the friction lining 7, 7′. This sealing segment 21 or 22 prevents radial loss of cooling oil in the region in which the cooling oil current is deflected in the clutch pack 14.

Since the disks 3 and 5, used in the exemplary embodiment according to FIG. 1, are such that they carry a friction lining 7 or 7′ only on one side, in the present case pointing to the left, another seal 27 is provided between the end disk 8 and the axially next external disk 5 to prevent leakage of the cooling oil 13 in the transfer region and the seal being disposed or configured either on this end disk 8 or on this external disk 5.

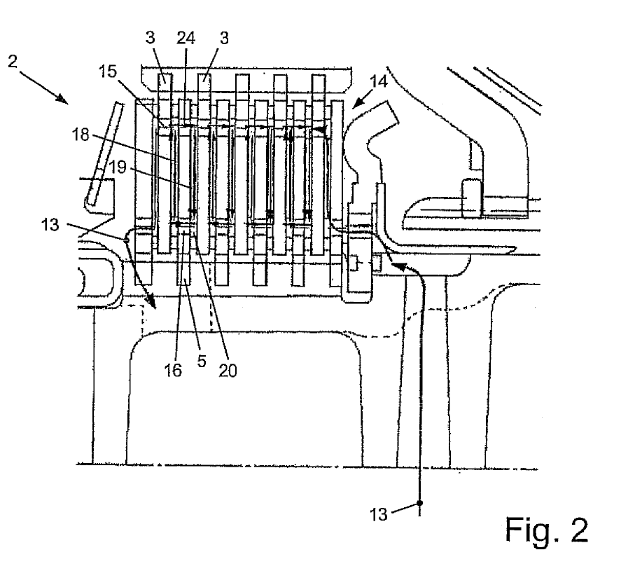

The second variant of an inventive multi-disk brake 2, shown according to FIG. 2, differs from the multi-disk brake 1 according to FIG. 1 only in that the cooling oil 13 flows through the clutch pack 14 not only alternately axially and radially, but also that a circulatory flow about the external disks 5 or about substantial radial and axial sections of the same is produced. This cooling oil current, which is advantageous for fast heat dissipation, is achieved by additional axial orifices 24 in the external disks 5 in the region of the radial ends thereof removed from the disk carrier.

This circulatory current alternately can be produced on the internal disks 3 if these instead of the external disks 5 have the axial orifices in the region of the radially inner and outer ends thereof.

In order to facilitate axial flow through the clutch pack 14 of the multi-disk brake 2 according to FIG. 2, the axial orifices 15, 16 or 24, in the internal disks 3 or in the external disks 5, can have different diameters and/or different flow resistance values. In this way, the design allows a predefined adjustment of the volume flow of the cooling oil, in the axial direction, through the clutch pack 14 and of the circulatory volume flow about the disks 3 and/or 5.

### REFERENCE NUMBERS

1 Multi-disk brake, multi-disk clutch
2 Multi-disk brake, multi-disk clutch
3 Internal disk
4 Inner disk carrier
5 External disk
6 Outer disk carrier
7 Friction lining
7′ Friction lining
8 End disk on inflow side
9 End disk on piston side
10 Piston
11 Disk spring
12 Housing
13 Cooling oil
14 Clutch pack
15 Axial orifice in internal disk
16 Axial orifice in external disk
17 Radial end of an internal disk
18 Radial end of an external disk
19 Radial groove in external disk
20 Radial groove in internal disk
21 Sealing segment
22 Sealing segment
23 Synchronizing teeth element
24 Axial orifice
25 Inflow opening in end disk on inflow side
26 Discharge opening in end disk on piston side

1.-16. (canceled)

17. A multi-disk element (1, 2) comprising:
an inner disk carrier (4) carrying internal disks (3) with the internal disks (3) carrying friction linings (7); and
an outer disk carrier (6) carrying external disks (5) with the external disks (5) carrying friction linings (7′);
a first end disk (9), against which an engaging force is applied by a piston (10) of a piston-cylinder arrangement which can be actuated by a pressure medium; and
a second end disk (8) forms an axial abutment for the clutch pack (14) formed by the internal, the external, the first and the second end disks (3 5, 8, 9); and at least the multi-disk element (1, 2) being configured such that the internal and the external disks (3, 5) are wetted, during operation, with a cooling oil (13);
wherein multi-disk element (1, 2) is configured such that the cooling oil (13) is directed axially through the clutch pack (14) during operation.

18. The multi-disk element (1, 2) according to claim 17, wherein the multi-disk element (1, 2) is configured such that the cooling oil (13) is directed alternately axially and radially through the clutch pack (14).

19. The multi-disk element (1, 2) according to claim 17, wherein the first and the second end disks (8, 9) are each provided with at least one axial orifice (25, 26) through which the cooling oil (13) is directed axially therethrough.

20. The multi-disk element (1, 2) according to claim 17, wherein each of the internal disks (3) and the external disks (5) has at least one axial orifice (15, 16) therein.

21. The multi-disk element (1, 2) according to claim 20, wherein the at least one axial orifice (15, 16), provided in each of the internal disks (3) and the external disks (5), is provided a radial distance in front of a radial end (17, 18) of the respective disk (3, 5).

22. The multi-disk element (1, 2) according to claim 20, wherein the at least one axial orifice (15, 16), provided in each of the internal disks (3) and the external disks (5), are disposed one of radially removed from and radially close to one of the inner disk carrier (4) and outer disk carrier (6).

23. The multi-disk element (1, 2) according to claim 17, wherein the internal disks (3) and external disks (5) each carry a friction lining (7, 7′) only on one axial side and that friction lining (7, 7′), within the clutch pack (14), points in the same axial direction.

24. The multi-disk element (1, 2) according to claim 17, wherein the cooling oil (13) is directed at least partially through radial grooves (19, 20) in the friction lining (7, 7′) of each of the internal disk (3) and the external disk (5).

25. The multi-disk element (1, 2) according to claim 24, wherein at least one groove (19, 20), in the friction lining (7, 7′), is configured one of radially straight and radially arched.

26. The multi-disk element (1, 2) according to claim 17, wherein a radial sealing segment (21, 22) is provided in a region of a radial end (17, 18) of each internal disk (3) and each external disk (5), carrying a friction lining (7, 7′), which prevents cooling oil (13) from radially exiting the clutch pack (14).

27. The multi-disk element (1, 2) according to claim 26, wherein the sealing segment (21, 22) is made from one of a same material as the friction lining (7, 7′) and a separate sealant that is applied to the internal disk (3) and the external disk (5).

28. The multi-disk element (1, 2) according to claim 17, wherein a synchronizing teeth element (23), on the disk carrier (6) that provides the oil supply, has no teeth in the catch profile in the region of the transfer point for the cooling oil (13).

29. The multi-disk element (1, 2) according to claim 17, wherein at least some of the internal disks (3) and the external disks (5) axially encompassed by the two end disks (8, 9) have at least one radially inner opening (24) and also at least one radially outer opening (16).

30. The multi-disk element (1, 2) according to claim 29, wherein the orifices (16, 24) in the internal disk (3) and the external disk (5) are disposed radially removed from one another and have at least one of different diameters and different flow resistance values.

31. The multi-disk element (1, 2) according to claim 17, wherein the cooling oil (13) is fed under pressure to the multi-disk element (1, 2).

32. The multi-disk element (1, 2) according to claim 17, wherein the cooling oil (13) is pumped into an annular oil collecting chamber, provided adjacent the end disk (8) on the inflow side in the region of the multi-disk element (1, 2), before passing through the clutch pack (14).

33. The multi-disk element (1, 2) according to claim 17, wherein the multi-disk element (1, 2) is one of a multi-disk clutch and a multi-disk brake (1, 2).

34. A multi-disk clutch or multi-disk brake (1, 2) comprising:
an inner disk carrier (4) carrying internal disks (3) having friction linings (7); and
an outer disk carrier (6) carrying external disks (5) having friction linings (7′);
a first end disk (9), against which an engaging force is applied by a piston (10) of a piston-cylinder arrangement which can be actuated by a pressure medium; and
a second end disk (8) forms an axial abutment for the clutch pack (14) formed by the internal, the external, the first and the second end disks (3, 5, 8, 9),
the multi-disk clutch or multi-disk brake (1, 2) and/or the components encompassing the clutch or the brake being configured such that the internal and the external disks (3, 5) are wetted, during operation, with a cooling oil (13),
wherein the multi-disk clutch or multi-disk brake (1, 2) is configured such that the cooling oil (13) is directed axially through the clutch pack (14) during operation.
